(19) United States
(12) Patent Application Publication
(10) Pub. No.: US 2012/0188638 A1
(43) Pub. Date: Jul. 26, 2012

(54) METHOD FOR MANUFACTURING POLARIZING PLATE

(75) Inventors: Mie Nakata, Ibaraki-shi (JP); Nobuaki Iwamoto, Ibaraki-shi (JP); Tetsurou Takeda, Ibaraki-shi (JP)

(73) Assignee: NITTO DENKO CORPORATION, Osaka (JP)

(21) Appl. No.: 13/357,885

(22) Filed: Jan. 25, 2012

(30) Foreign Application Priority Data
Jan. 26, 2011 (JP) 2011-014357

(51) Int. Cl. G02B 5/30; B32B 38/00; B32B 37/00

(52) U.S. Cl. 359/485.01; 156/273.3

(57) ABSTRACT

A method for manufacturing a polarizing plate, which is free of appearance defects caused by dents, contaminants, or scratches, and has an improved adhering strength between a polarizer and a cycloolefin-based resin film, includes the steps of performing a corona discharge treatment at a power density of 0.9 to 2.5 kW on the surface of a cycloolefin-based resin film where a polarizer is to be placed; washing, with water, the corona discharge-treated cycloolefin-based resin film; and bonding a polarizer to the cycloolefin-based resin film with an adhesive interposed therebetween.

### FIELD OF THE INVENTION

The present invention relates to a method for manufacturing a polarizing plate. The invention also relates to a polarizing plate obtained by the manufacturing method. The polarizing plate may be used alone or in the form of a laminated optical film to form an image display device such as a liquid crystal display (LCD), an organic electroluminescence (EL) display, a cathode ray tube (CRT), or a plasma display panel (PDP).

### BACKGROUND ART

Liquid crystal display devices use liquid crystal switching to visualize the polarization state, and based on the display principle, they use a polarizing plate including a polarizer and transparent protective films bonded to both sides of the polarizer with an adhesive layer. As polarizers, for example, iodine-based polarizers are generally used, which have a structure obtained by adsorbing iodine onto polyvinyl alcohol and stretching polyvinyl alcohol. Transparent protective films generally used include triacetylcellulose-based films, cycloolefin-based resin films, etc.

Unfortunately, conventional polarizing plates have a problem in which when they are exposed to a high temperature/high humidity environment, peeling easily occurs between the polarizer and the transparent protective film.

The techniques described below have been proposed to solve this problem.

Patent document 1 proposes that the surface of a thermoplastic saturated norbornene resin film should be corona discharge-treated so that the adhesion to the polarizer can be improved.

Patent document 2 and 3 propose that a surface treatment for improving adhesion, such as a plasma treatment, a corona treatment, or an ultraviolet irradiation treatment should be performed on the surface of a polarizing film and/or a protective film to be bonded.

Patent document 4 proposes that in order to improve the adhesion between a polarizing film and a cycloolefin-based resin film, a corona discharge treatment at a power density of 800 W or less should be performed on the surface of the cycloolefin-based resin film on the side where the polarizing film is to be bonded.

Patent document 5 proposes a process for stabilizing adhering strength, which includes subjecting a low adhesion film such as a TAC film to a plasma treatment and then washing the film with water or the like to remove low-adhesion bleeding products on the surface.

### PRIOR ART DOCUMENTS

### Patent Documents

Patent document 1: JP-A 2000-241627

Patent document 2: JP-A 2005-70140

Patent document 3: JP-A 2005-181817

Patent document 4: JP-A 2007-279621

Patent document 5: JP-A 2010-150373

### DISCLOSURE OF THE INVENTION

### Problems to be Solved by the Invention

An object of the invention is to provide a method for manufacturing a polarizing plate that is free of appearance defects caused by dents, contaminants, or scratches, and has an improved adhering strength between a polarizer and a cycloolefin-based resin film.

Another object of the invention is to provide a polarizing plate obtained by such a manufacturing method. A further object of the invention is to provide an optical film including a laminate having such a polarizing plate and to provide an image display device such as a liquid crystal display device produced using such a polarizing plate or optical film.

### Solutions to the Problems

As a result of earnest studies to solve the above problems, the inventors have accomplished the invention based on the finding that the objects can be achieved by the polarizing plate-manufacturing method described below.

Thus, the invention is directed to a method for manufacturing a polarizing plate including a polarizer and a cycloolefin-based resin film provided on at least one surface of the polarizer with an adhesive layer interposed therebetween, which includes the steps of: performing a corona discharge treatment at a power density of 0.9 kW to 2.5 kW on the surface of a cycloolefin-based resin film where a polarizer is to be placed; washing, with water, the corona discharge-treated cycloolefin-based resin film; and bonding a polarizer to the cycloolefin-based resin film with an adhesive interposed therebetween.

When the surface of a cycloolefin-based resin film undergoes a corona discharge treatment, a fine powdery substance (carboxylic acid derivative) is derived and released from the cycloolefin-based resin. During a long running operation on an industrial scale, the fine powdery substance builds up to contaminate the factory area. There is also a problem in which the fine powdery substance can cause degradation of the performance or appearance of the polarizing plate. For example, if the fine powdery substance is deposited on a feed roller, dents can be formed on the polarizer or the cycloolefin-based resin film, or if the fine powdery substance remains on the surface of the cycloolefin-based resin film, the foreign substance can cause the production of defective polarizing plates.

The inventors have found that when the fine powdery substance is removed by a cleaning process using water or the like, a polarizing plate having good adhesion between the polarizer and the cycloolefin-based resin film and being free of appearance defects, which are caused by dents or contaminants, is successfully obtained.

The power density of the corona discharge is needed to be from 0.9 to 2.5 kW. If the power density is less than 0.9 kW, the production of the fine powdery substance can be suppressed, but the corona discharge treatment cannot be uniformly performed in the width direction of the film, so that uneven modification will occur and the adhering strength will not increase. On the other hand, if the power density is more than 2.5 kW, corona damage to the surface of the film will be more likely to occur, so that defective polarizing plates will be more likely to be produced.

The invention is also directed to a polarizing plate obtained by the manufacturing method.

The invention is also directed to an optical film including a laminate having at least one piece of the polarizing plate.

The invention is also directed to an image display device including the polarizing plate or the optical film.

### Effects of the Invention

According to the invention, the cycloolefin-based resin film is subjected to a corona discharge treatment before the polarizer is bonded to the cycloolefin-based resin film with an adhesive. The corona discharge treatment introduces hydrophilic functional groups (such as —COOH and —OH) or radical active species to the surface of the film, and roughens the surface of the film. In addition, the fine powdery substance produced by the corona discharge treatment is removed by the cleaning process using water or the like. Thus, the resulting polarizing plate has an increased adhering strength between the polarizer and the cycloolefin-based resin film and resists peeling between the polarizer and the cycloolefin-based resin film even when exposed to a high temperature/high humidity environment for a long time. When the power density in the corona discharge treatment is controlled in the range of 0.9 to 2.5 kW, the surface of the film can be uniformly modified without suffering from corona damage.

### Embodiments for Carrying out the Invention

The polarizer to be used in the method of the invention for manufacturing a polarizing plate may be of any type. For example, the polarizer may be a product produced by a process including adsorbing a dichroic material such as iodine or a dichroic dye onto a hydrophilic polymer film such as a polyvinyl alcohol-based film, a partially-formalized polyvinyl alcohol-based film, or a partially-saponified, ethylene-vinyl acetate copolymer-based film and uniaxially stretching the film or may be a polyene-based oriented film such as a film of a dehydration product of polyvinyl alcohol or a dehydrochlorination product of polyvinyl chloride. In particular, a polarizer including a polyvinyl alcohol-based film and a dichroic material such as iodine is advantageous.

The polyvinyl alcohol-based polarizer to be used may be a uniaxially-stretched polyvinyl alcohol resin film dyed with a dichroic material (typically, iodine or a dichroic dye). The polyvinyl alcohol-based resin of the polyvinyl alcohol-based resin film preferably has a degree of polymerization of 100 to 10,000, more preferably 1,000 to 5,000. If the degree of polymerization is too low, the film may easily break during a certain stretching process. If the degree of polarization is too high, an abnormal tension may be necessary for stretching, so that mechanical stretching may be impossible.

The polyvinyl alcohol-based resin film used to form the polarizer may be formed by any appropriate method such as a solution casting method including casting a solution of the resin in water or an organic solvent to form a film, a casting method, or an extrusion method. The thickness of the polarizer is generally from about 10 to about 300 μm, preferably from 20 to 100 μm, while it may be appropriately selected depending on the purpose or intended use of the LCD to be produced using the polarizing plate.

Any appropriate method may be used to produce the polarizer, depending on the purpose, the materials to be used, and the conditions. For example, a method that may be used includes subjecting the polyvinyl alcohol-based resin film to a series of manufacturing steps generally including swelling, dyeing, crosslinking, stretching, washing with water, and drying. Except for the drying step, each step may be performed while the polyvinyl alcohol-based resin film is immersed in a liquid containing a solution necessary for each step. Concerning the steps of swelling, dyeing, crosslinking, stretching, washing with water, and drying, the order of the steps, the number of times of each step, and the presence or absence of each step may be appropriately determined depending on the purpose, the materials to be used, and the conditions. For example, some steps may be simultaneously performed in a single process, and swelling, dyeing, and crosslinking may be performed at the same time. For example, crosslinking before or after stretching is advantageously employed. For example, washing with water may be performed after all of the other steps or only after a certain step.

The cycloolefin-based resin film used in the method of the invention for producing a polarizing plate may be of any known type. Cycloolefin-based resin is a generic name for resins produced by polymerization of cycloolefin as a polymerizable unit, and examples thereof include the resins disclosed in JP-A Nos. 01-240517, 03-14882, and 03-122137. Specific examples thereof include ring-opened (co)polymers of cycloolefin(s), addition polymers of cycloolefin(s), copolymers (typically random copolymers) of cycloolefin(s) and α-olefin(s) such as ethylene or propylene, graft polymers produced by modification thereof with an unsaturated carboxylic acid or a derivative thereof, and hydrides thereof. Examples of cycloolefin include norbornene monomers.

Cycloolefin-based resins have various commercially available sources. Examples thereof include ZEONEX (trade name) and ZEONOR (trade name) series manufactured by ZEON CORPORATION, ARTON (trade name) series manufactured by JSR Corporation, TOPAS (trade name) series manufactured by Ticona, and APEL (trade name) series manufactured by Mitsui Chemicals, Inc.

The cycloolefin-based resin film may be provided as a transparent protective film on one or both sides of the polarizer. When it is provided on one side of the polarizer, any known transparent protective film may be provided on the other side.

For example, thermoplastic resin with a high level of transparency, mechanical strength, thermal stability, water-blocking properties, isotropy, or other properties may be used as a material to form the transparent protective film. Examples of such thermoplastic resin include cellulose resin such as triacetylcellulose, polyester resin, polyethersulfone resin, polysulfone resin, polycarbonate resin, polyamide resin, polyimide resin, polyolefin resin, (meth)acrylic resin, polyarylate resin, polystyrene resin, polyvinyl alcohol resin, and any blend thereof. Thermosetting or ultraviolet-curable resin such as (meth)acrylic, urethane, acrylic urethane, epoxy, or silicone resin may also be used.

While the thickness of the cycloolefin-based resin film and the transparent protective film may be determined as appropriate, it is generally from about 1 to about 500 μm, preferably from 1 to 300 μm, more preferably from 5 to 200 μm, in particular, preferably from 5 to 150 μm, in view of strength, workability such as handleability, thin layer formability, or the like.

The transparent protective film to be used may be a retardation plate having an in-plane retardation of 40 nm or more and/or a thickness direction retardation of 80 nm or more. The in-plane retardation is generally controlled in the range of 40 to 200 nm, and the thickness direction retardation is generally controlled in the range of 80 to 300 nm. The retardation plate for use as the transparent protective film also has the function of the transparent protective film and thus can contribute to a reduction in thickness.

Examples of the retardation plate include a birefringent film produced by uniaxially or biaxially stretching a polymer material, an oriented liquid crystal polymer film, and an oriented liquid crystal polymer layer supported on a film. While the thickness of the retardation plate is also not restricted, it is generally from about 20 to about 150 μm.

The retardation function may also be provided by bonding an additional film having such a retardation to a transparent protective film having no retardation.

The other side of the cycloolefin-based resin film or the transparent protective film from the side where the polarizer is bonded may be subjected to a hard-coating treatment, an antireflection treatment, an anti-sticking treatment, or a treatment for diffusion or antiglare purpose.

Alternatively, an additional layer such as a hard-coat layer, an antireflection layer, an anti-sticking layer, a diffusion layer, or an antiglare layer may be formed on the cycloolefin-based resin film or the transparent protective film.

The adhesive for use in bonding the polarizer and the cycloolefin-based resin film may be any of various types such as a water-based type, a solvent-based type, a hot melt type, and a radical-curable type, as long as it is optically transparent. In particular, a water-based adhesive is advantageous.

For example, the water-based adhesive may be of a polyvinyl alcohol type, a gelatin type, a vinyl latex type, a polyurethane type, an isocyanate type, a polyester type, or an epoxy type. The adhesive may contain any of various crosslinking agents. The adhesive may also contain a catalyst, a coupling agent, any of various tackifiers, an ultraviolet-absorbing agent, an antioxidant, or a stabilizer such as a heat-resistant stabilizer or a hydrolysis-resistant stabilizer. The adhesive to be used generally has a solids content of 0.1 to 20% by weight.

Among the above adhesives, a polyvinyl alcohol-based adhesive is preferred. The polyvinyl alcohol-based adhesive should contain a polyvinyl alcohol-based resin and a crosslinking agent.

Examples of the polyvinyl alcohol-based resin include polyvinyl alcohol obtained by saponification of polyvinyl acetate; derivatives thereof; saponification products of a copolymer of vinyl acetate and a copolymerizable monomer; and modified polyvinyl alcohol obtained by subjecting polyvinyl alcohol to acetalization, urethanization, etherification, grafting, phosphoesterification, or the like. Examples of the monomer include unsaturated carboxylic acids such as maleic acid (anhydride), fumaric acid, crotonic acid, itaconic acid, and (meth)acrylic acid, and esters thereof; α-olefins such as ethylene and propylene; (sodium) (meth)allylsulfonate, sodium sulfonate(monoalkyl maleate), sodium disulfonate alkyl maleate, N-methylolacrylamide, acrylamide alkyl sulfonate alkali salts, N-vinylpyrrolidone, and N-vinylpyrrolidone derivatives. These polyvinyl alcohol-based resins may be used alone or in combination of two or more.

In view of adhesion, a non-limiting example of the polyvinyl alcohol-based resin has an average polymerization degree of about 100 to about 3,000, preferably 500 to 3,000, and an average saponification degree of about 85 to about 100% by mole, preferably 90 to 100% by mole.

The polyvinyl alcohol-based resin to be used may be an acetoacetyl group-containing polyvinyl alcohol resin. The acetoacetyl group-containing polyvinyl alcohol resin can form a polyvinyl alcohol-based adhesive having a highly reactive functional group and is preferred for improving the durability of the polarizing plate.

The crosslinking agent may be of any type used in polyvinyl alcohol-based adhesives. The crosslinking agent to be used may be a compound having at least two functional groups reactive with the polyvinyl alcohol-based resin. Examples include alkylenediamines having an alkylene group and two amino groups, such as ethylenediamine, triethylenediamine, and hexamethylenediamine; isocyanates such as tolylene diisocyanate, hydrogenated tolylene diisocyanate, trimethylolpropane tolylene diisocyanate adducts, triphenylmethane triisocyanate, methylene bis(4-phenylmethane)triisocyanate, isophorone diisocyanate, and ketoxime blocked compounds or phenol blocked compounds thereof; epoxies such as ethylene glycol diglycidyl ether, polyethylene glycol diglycidyl ether, glycerin di- or triglycidyl ether, 1,6-hexanediol diglycidyl ether, trimethylolpropane triglycidyl ether, diglycidyl aniline, and diglycidyl amine; monoaldehydes such as formaldehyde, acetaldehyde, propionaldehyde, and butylaldehyde; dialdehydes such as glyoxal, malondialdehyde, succindialdehyde, glutardialdehyde, maleic dialdehyde, and phthaldialdehyde; amino-formaldehyde resins such as condensates of formaldehyde with methylolurea, methylolmelamine, alkylated methylolurea, alkylated methylolmelamine, acetoguanamine, or benzoguanamine; and salts of divalent or trivalent metals such as sodium, potassium, magnesium, calcium, aluminum, iron, and nickel and oxides thereof. The crosslinking agent is preferably a melanine crosslinking agent, in particular, preferably methylolmelamine.

The added amount of the crosslinking agent is generally from about 0.1 to about 35 parts by weight, preferably from 10 to 25 parts by weight, based on 100 parts by weight of the polyvinyl alcohol-based resin. In order to further improve durability, the crosslinking agent may be added in an amount of more than 30 to 46 parts by weight to 100 parts by weight of the polyvinyl alcohol-based resin. Particularly when an acetoacetyl group-containing polyvinyl alcohol-based resin is used, the crosslinking agent is preferably used in an amount of more than 30 parts by weight. When the crosslinking agent is added in an amount of more than 30 to 46 parts by weight, water resistance will be improved.

The adhesive may also contain a coupling agent such as a silane coupling agent or a titanium coupling agent, any of various tackifiers, an ultraviolet absorber, an antioxidant, a stabilizer such as a heat-resistant stabilizer or a hydrolysis-resistant stabilizer, or the like.

The adhesive may also contain a metal compound filler. When a metal compound filler is used, the fluidity of the adhesive can be controlled so that the coating thickness can be stabilized, which makes it possible to obtain a polarizing plate with good appearance and in-plane uniformity without variations in adhesion.

Various types of metal compound fillers may be used. Examples of the metal compound include a metal oxide such as alumina, silica, zirconia, titania, aluminum silicate, calcium carbonate, or magnesium silicate; a metal salt such as zinc carbonate, barium carbonate, or calcium phosphate; and a mineral such as celite, talc, clay, or kaolin. These metal compound fillers may be subjected to surface modification.

The average particle size of the metal compound filler is generally from about 1 to about 1,000 nm, preferably from 1 to 500 nm, more preferably from 10 to 200 nm, even more preferably from 10 to 100 nm. When the average particle size of the metal compound filler is in the above range, the metal compound can be substantially uniformly dispersed in the adhesive layer, which makes it possible to ensure adhesion and to obtain good appearance and uniform in-plane adhesion.

The metal compound filler is preferably added in an amount of 100 parts by weight or less, based on 100 parts by weight of the curable component. When the content of the metal compound filler is in the above range, good appearance and uniform in-plane adhesion can be obtained together with reliable adhesion between the polarizer and the transparent protective film. The content of the metal compound filler is preferably from 1 to 100 parts by weight, more preferably from 2 to 50 parts by weight, even more preferably from 5 to 30 parts by weight. If the content of the metal compound filler is more than 100 parts by weight based on 100 parts by weight of the curable component, the content of the curable component in the adhesive may be undesirably low in view of adhesion. The lower limit of the content of the metal compound filler is preferably, but not limited to, a value in the above range, in order that good appearance and uniform in-plane adhesion may be obtained together with reliable adhesion.

The polarizing plate is produced by bonding the polarizer and the cycloolefin-based resin film with the adhesive interposed therebetween, in which the process of the invention is characterized by including: performing a corona discharge treatment at a power density of 0.9 to 2.5 kW on the surface of the cycloolefin-based resin film where the polarizer is to be placed; and then washing, with water, the corona discharge-treated cycloolefin-based resin film, before bonding them together.

The corona discharge treatment may be performed by a process including placing the cycloolefin-based resin film between electrodes and applying a high voltage across the electrodes in atmospheric pressure air to perform discharging. While the treatment conditions other than the power density are not restricted, the distance between the electrodes should be from about 1 to about 5 mm, and the film feed rate should be about 3 to about 20 m/minute. The power density is preferably from 0.9 to 2.0 kW.

When a transparent protective film is provided on the other side of the polarizer, a surface modification treatment may also be performed on the transparent protective film. Examples of such a treatment include a corona discharge treatment, a plasma discharge treatment, an ultraviolet irradiation treatment, a flame treatment, a primer treatment, and a saponification treatment.

For example, the water washing process may be a process of immersing the corona discharge-treated cycloolefin-based resin film in an aqueous cleaning liquid bath or a process of applying or spraying an aqueous cleaning liquid onto the corona discharge-treated surface of the cycloolefin-based resin film.

The aqueous cleaning liquid may be an aqueous solution containing pure water or ion-exchanged water and an enzyme-based cleaning agent. The temperature of the aqueous cleaning liquid is preferably, but not limited to, 5 to 80° C., more preferably 10 to 50° C. If the temperature is less than 5° C., dew condensation can be more likely to occur on the surface of the film after the water washing process. If it is higher than 80° C., the film may become wrinkled due to heat, so that handleability may tend to be poor. The time of the water washing process is typically, but not limited to, about 3 to about 180 seconds, preferably 5 to 120 seconds. If the process time is too short, it may be difficult to remove fine powdery materials sufficiently from the surface of the film, and if the process time is too long, production efficiency may be undesirably reduced.

After the water washing process, drops of water remaining on the surface of the film are preferably removed using a nip roll, a glass bar, an air knife, or the like.

Subsequently, the cycloolefin-based resin film and the polarizer are bonded together with the adhesive, so that the polarizing plate is obtained. The adhesive may be applied to any one or both of the corona discharge-treated surface of the cycloolefin-based resin film and the surface of the polarizer. After the bonding, drying may be performed so that an adhesive layer can be formed. When a water-based adhesive is used, the drying may be performed at a temperature of about 20 to about 80° C., preferably 40 to 80° C., for about 1 to about 10 minutes, preferably 1 to 5 minutes. The cycloolefin-based resin film and the polarizer may be bonded using a roll laminator or the like. The thickness of the adhesive layer is generally, but not limited to, about 30 to about 1,000 nm.

For practical use, the polarizing plate of the invention may be laminated with any other optical layer or layers to form an optical film. Such an optical layer or layers may be, but not limited to, one or more optical layers that have ever been used to form liquid crystal display devices, etc., such as a reflector, a transflector, a retardation plate (including a wavelength plate such as a half or quarter wavelength plate), or a viewing angle compensation film. Specifically preferred is a reflective or transflective polarizing plate including a laminate of the polarizing plate of the invention and a reflector or a transflector, an elliptically or circularly polarizing plate including a laminate of the polarizing plate and a retardation plate, a wide viewing angle polarizing plate including a laminate of the polarizing plate and a viewing angle compensation film, or a polarizing plate including a laminate of the polarizing plate and a brightness enhancement film.

The optical film including a laminate of the polarizing plate and the optical layer may be formed by a method of stacking them one by one in the process of manufacturing a liquid crystal display device or the like. However, an optical film formed by previous lamination has the advantage that it can facilitate the process of manufacturing a liquid crystal display device or the like, because it has stable quality and good assembling workability. In the lamination, any appropriate bonding means such as a pressure-sensitive adhesive layer may be used. When the polarizing plate and any other optical film are bonded together, their optical axes may be each aligned at an appropriate angle, depending on the desired retardation properties or other desired properties.

A pressure-sensitive adhesive layer for bonding to any other member such as a liquid crystal cell may also be provided on the polarizing plate or the optical film including a laminate having at least one layer of the polarizing plate. For example, the pressure-sensitive adhesive for use in forming the pressure-sensitive adhesive layer may be appropriately selected from, but not limited to, pressure-sensitive adhesives containing, as a base polymer, an acryl-based polymer, a silicone-based polymer, polyester, polyurethane, polyamide, polyether, a fluoropolymer, or a rubber polymer. In particular, preferably used is a pressure-sensitive adhesive having a high level of optical transparency, weather resistance, and heat resistance and exhibiting an appropriate degree of wettability, cohesiveness, and adhesion, such as an acrylic pressure-sensitive adhesive.

The pressure-sensitive adhesive layer may be formed on one or both sides of the polarizing plate or the optical film by any appropriate method. Examples of such a method include: a method including dissolving or dispersing a base polymer or a composition thereof in an appropriate single solvent such as toluene or ethyl acetate or a mixture thereof to prepare an about 10 to 40% by weight pressure-sensitive adhesive solution and directly applying the solution to the polarizing plate or the optical film by any appropriate spreading method such as casting or coating; and a method including forming a pressure-sensitive adhesive layer on a separator similarly to the above method and transferring it onto the polarizing plate or the optical film.

The pressure-sensitive adhesive layer may also be formed as a laminate of layers different in composition, type or the like on one or both sides of the polarizing plate or the optical film. When pressure-sensitive adhesive layers are provided on both sides, they may be different in composition, type, thickness, or the like between the front and back sides of the polarizing plate or the optical film. The thickness of the pressure-sensitive adhesive layer is generally from 1 to 500 μm, preferably from 5 to 200 μm, in particular, preferably from 10 to 100 μm, while it may be determined depending on the purpose of use, adhering strength or the like.

The exposed surface of the pressure-sensitive adhesive layer may be temporarily covered with a separator for antifouling or the like until it is put to use. This can prevent contact with the pressure-sensitive adhesive layer during usual handling. According to conventional techniques, without concerning the thickness conditions, an appropriate separator may be used such as a plastic film, a rubber sheet, a paper sheet, a cloth, a nonwoven fabric, a net, a foam sheet, a metal foil, any laminate thereof, or any other appropriate thin material, which are optionally coated with any appropriate release agent such as a silicone, long-chain alkyl, or fluoride release agent, or molybdenum sulfide.

In an embodiment of the invention, an ultraviolet absorbing capability may be imparted to the polarizer, the transparent protective film, the optical film, or any other layer such as the pressure-sensitive adhesive layer, for example, by treatment with an ultraviolet absorber such as a salicylate ester compound, a benzophenol compound, a benzotriazole compound, a cyanoacrylate compound, or a nickel complex salt compound.

The polarizing plate or optical film of the invention is preferably used to form various devices such as liquid crystal display devices. Liquid crystal display devices may be formed according to conventional techniques. Specifically, a liquid crystal display device may be typically formed by assembling a liquid crystal cell, polarizing plates or optical films, and an optional component such as a lighting system, and incorporating a driving circuit according to any conventional techniques, except that the polarizing plate or the optical film according to the invention is used. The liquid crystal cell to be used may also be of any type such as TN type, STN type, or n type.

Any desired liquid crystal display device may be formed, such as a liquid crystal display device including a liquid crystal cell and the polarizing plate or the optical film placed on one or both sides of the liquid crystal cell or a liquid crystal display device further including a backlight or a reflector in a lighting system. In such a case, the polarizing plate or the optical film according to the invention may be placed on one or both sides of the liquid crystal cell. When polarizing plates or optical films are provided on both sides, they may be the same or different. The process of forming a liquid crystal display device may also include placing an appropriate component such as a diffusion plate, an antiglare layer, an anti-reflection film, a protective plate, a prism array, a lens array sheet, a light diffusion plate, or a backlight in one or more layers at an appropriate position or positions.

### EXAMPLES

Hereinafter, some examples of the invention will be described, which are not intended to limit the embodiments of the invention.

### Example 1

(Polarizer)

A 75 μm thick polyvinyl alcohol film with an average degree of polymerization of 2,400 and a degree of saponification of 99.9% by mole was immersed in warm water at 30° C. for 60 seconds, so that it was allowed to swell. The film was then stretched to 3.5 times, while it was immersed and dyed in a 0.3% iodine solution containing iodine/potassium iodide (0.5/8 in weight ratio). Subsequently, the film was stretched to a total stretch ratio of 6 in a boric acid ester solution at 65° C. Subsequently, the film was dried in an oven at 40° C. for 3 minutes to give a polarizer.

(Transparent Protective Films)

The transparent protective films used were a ZEONOR film, which was a 73 μm thick norbornene-based resin film (ZB14 film, manufactured by ZEON CORPORATION), and a saponified 80 μm thick TAC film (TD80UL, manufactured by Fujifilm Corporation).

(Water-Based Adhesive)

Under the condition of a temperature of 30° C., 100 parts by weight of an acetoacetyl group-containing polyvinyl alcohol-based resin (1,200 in average degree of polymerization, 98.5% by mole in degree of saponification, 5% by mole in degree of acetoacetylation) and 50 parts by weight of methylol melamine were dissolved in pure water to form an aqueous solution with a solids content of 3.7% by weight. A water-based adhesive was prepared by adding, to 100 parts by weight of the aqueous solution, 18 parts by weight of an aqueous alumina colloidal solution (15 nm in average particle size, 10% in solids content, positively charged). The water-based adhesive had a viscosity of 9.6 mPa·s and a pH in the range of 4 to 4.5.

(Corona Discharge Treatment)

One side of the ZEONOR film was subjected to a corona discharge treatment using a corona discharge machine (CT-0212, manufactured by KASUGA DENKI, Inc.). The treatment conditions were an electrode-electrode distance of 2 mm, a film feed rate of 13 m/minute, and a power density of 0.9 kW.

(Water Washing Process)

The corona discharge-treated ZEONOR film was immersed in a water washing bath at 30° C. for 30 seconds, which was followed by removing drops of water from the surface of the film using a nip roller.

(Preparation of Polarizing Plate)

The water-based adhesive was applied to each of the corona discharge-treated surface of the ZEONOR film and the saponified surface of the TAC film so that the coating could have a thickness of 100 nm after drying. Subsequently, these films were bonded to both sides of the polarizer using a roller. The resulting laminate was then dried at 70° C. for 10 minutes to give a polarizing plate.

### Examples 2 to 5 and Comparative Examples 1 to 10

Polarizing plates were prepared using the same method as in Example 1, except that as shown in Table 1, the power density in the corona discharge was changed or the water washing process was omitted.

[Evaluation]

The ZEONOR film and the polarizing plate prepared in each of the examples and the comparative examples were evaluated as described below. The results are shown in Table 1.

(Discharge State)

The corona discharge-treated surface of the ZEONOR film was visually observed. The case where the discharge treatment was uniform was evaluated as “◯,” and the case where the discharge treatment was uneven was evaluated as “×.”

(Adhesion)

The edge of a cutter knife was inserted between the polarizer and the ZEONOR film at the end of the polarizing plate. At the incision part, the polarizer and the ZEONOR film were pinched and pulled in opposite directions, respectively. In this process, the case where the polarizer and/or the ZEONOR film was broken and not able to be peeled off was evaluated as “◯” (good adhesion), the case where partial peeling occurred between the polarizer and the ZEONOR film was evaluated as “Δ” (slightly poor adhesion), and the case where the polarizer was completely peeled off from the ZEONOR film was evaluated as “×” (poor adhesion).

(Appearance Evaluation)

The prepared polarizing plate was cut into a sample of 1,000 mm×1,000 mm. The sample was placed under a fluorescent lamp and visually measured for the number (/m²) of dents, the number (/m²) of contaminant defects, and the presence or absence of scratches.

TABLE 1

| | | | | | Appearance evaluation | | |
|---|---|---|---|---|---|---|---|
| | Power | | | | | Number of | Presence or |
| | density | Water | Discharge | | Number of | contaminant | absence of |
| | (kW) | washing | state | Adhesion | dents | defects | scratches |
| Example 1 | 0.9 | Present | ∘ | ∘ | 0 | 0 | Absent |
| Comparative | 0.9 | Absent | ∘ | ∘ | 5 | 1 | Absent |
| Example 1 | | | | | | | |
| Example 2 | 1.0 | Present | ∘ | ∘ | 0 | 0 | Absent |
| Comparative | 1.0 | Absent | ∘ | ∘ | 10 | 3 | Absent |
| Example 2 | | | | | | | |
| Example 3 | 1.5 | Present | ∘ | ∘ | 0 | 0 | Absent |
| Comparative | 1.5 | Absent | ∘ | ∘ | 15 | 3 | Absent |
| Example 3 | | | | | | | |
| Example 4 | 2.0 | Present | ∘ | ∘ | 0 | 0 | Absent |
| Comparative | 2.0 | Absent | ∘ | ∘ | 30 | 10 | Absent |
| Example 4 | | | | | | | |
| Example 5 | 2.5 | Present | ∘ | ∘ | 0 | 0 | Absent |
| Comparative | 2.5 | Absent | ∘ | ∘ | 55 | 20 | Absent |
| Example 5 | | | | | | | |
| Comparative | 3.0 | Absent | ∘ | ∘ | 89 | 33 | Present |
| Example 6 | | | | | | | |
| Comparative | 0.5 | Present | x | x | 0 | 0 | Absent |
| Example 7 | | | | | | | |
| Comparative | 0.5 | Absent | x | x | 0 | 0 | Absent |
| Example 8 | | | | | | | |
| Comparative | 0.8 | Present | x | Δ | 0 | 0 | Absent |
| Example 9 | | | | | | | |
| Comparative | 0.8 | Absent | x | Δ | 0 | 0 | Absent |
| Example 10 | | | | | | | |

What is claimed is:

1. A method for manufacturing a polarizing plate comprising a polarizer and a cycloolefin-based resin film provided on at least one surface of the polarizer with an adhesive layer interposed therebetween, comprising the steps of:
performing a corona discharge treatment at a power density of 0.9 kW to 2.5 kW on a surface of a cycloolefin-based resin film where a polarizer is to be placed;
washing, with water, the corona discharge-treated cycloolefin-based resin film; and
bonding a polarizer to the cycloolefin-based resin film with an adhesive interposed therebetween.

2. A polarizing plate obtained by the method according to claim 1.

3. An optical film comprising a laminate comprising at least one piece of the polarizing plate according to claim 2.

4. An image display device comprising the polarizing plate according to claim 2 or the optical film according to claim 3.
